(19) United States
(12) Patent Application Publication
(10) Pub. No.: US 2008/0212784 A1
(43) Pub. Date: Sep. 4, 2008

(54) Parametric Multi-Channel Decoding

(75) Inventors: Marek Szczerba, Eindhoven (NL); Andreas Johannes Gerrits, Eindhoven (NL); Marc Klein Middelink, Nijmegen (NL); Dieter Ernest Michel Therssen, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,458

(22) PCT Filed: Jul. 3, 2006
(86) PCT No.: PCT/IB2006/052221

§ 371 Date: Jan. 2, 2008

(30) Foreign Application Priority Data
Jul. 6, 2005 (EP) 05106138.0

(51) Int. Cl. H04R 5/00

(52) U.S. Cl. 381/1

(57) ABSTRACT

A sound decoding device (1) is arranged for decoding sound represented by sets of parameters, each set comprising sinusoidal parameters (SP) representing sinusoidal components of the sound and further parameters (NP, TP) representing further components of the sound, such as noise and/or transients. The device comprises a separate sinusoids generator unit (17, 18) for each output channel (L, R), while the further component generator units (20; 21) are shared between the channels.

The present invention relates to a parametric multi-channel decoder, such as a stereo decoder. More in particular, the present invention relates to a device and a method for synthesizing sound represented by sets of parameters, each set comprising sinusoidal parameters representing sinusoidal components of the sound and other parameters representing other components.

It is well known to represent sound by sets of parameters. So-called parametric coding techniques are used to efficiently encode sound, representing the sound by a series of parameters. A suitable decoder is capable of substantially reconstructing the original sound using the series of parameters. The series of parameters may be divided into sets, each set corresponding with an individual sound source (sound channel) such as a (human) speaker or a musical instrument.

The popular MIDI (Musical Instrument Digital Interface) protocol allows music to be represented by sets of instructions for musical instruments. Each instruction is assigned to a specific instrument. Each instrument can use one or more sound channels (called “voices” in MIDI). The number of sound channels that may be used simultaneously is called the polyphony number or the polyphony. The MIDI instructions can be efficiently transmitted and/or stored.

Synthesizers typically contain sound definition data, for example a sound bank or patch data. In a sound bank samples of the sound of instruments are stored as sound data, while patch data define control parameters for sound generators.

MIDI instructions cause the synthesizer to retrieve sound data from the sound bank and synthesize the sounds represented by the data. These sound data may be actual sound samples, that is digitized sounds (waveforms), as in the case of conventional wave-table synthesis. However, sound samples typically require large amounts of memory, which is not feasible in relatively small devices, in particular hand-held consumer devices such as mobile (cellular) telephones.

Alternatively, the sound samples may be represented by parameters, which may include amplitude, frequency, phase, and/or envelope shape parameters and which allow the sound samples to be reconstructed. Storing the parameters of sound samples typically requires far less memory than storing the actual sound samples. However, the synthesis of the sound may be computationally burdensome. This is particularly the case when many sets of parameters, representing different sound channels (“voices” in MIDI), have to be synthesized simultaneously (high degree of polyphony). The computational burden typically increases linearly with the number of channels (“voices”) to be synthesized, that is, with the degree of polyphony. This makes it difficult to use such techniques in hand-held devices.

The paper “Low Complexity Parametric Stereo Coding” by E. Schuijers, J. Breebaart, H. Purnhagen and J. Engdegård, Audio Engineering Society Convention Paper No. 6073, Berlin (Germany), May 2004, discloses a parametric audio decoder (FIG. 8). An audio signal has been decomposed into transient, sinusoidal and noise components, represented by parameters. This parametric representation of the audio signal may be stored in a sound bank. The parametric decoder (or synthesizer) uses this parametric representation to reconstruct the original audio input.

In the parametric coder of the Prior Art, sinusoids, transients and noise are subjected to directional processing: stereo parameters are used to create two output channels (left and right in stereo systems) out of a single channel. This directional processing is performed in a transform domain, such as the frequency or QMF (Quadrature Mirror Filter) domain, as this greatly increase the efficiency of the directional processing. However, in order to be able to perform the directional processing of the sinusoids, transients and noise in the transform domain, it is necessary to synthesize these sound components in the transform domain. It has been found that this significantly increases the complexity of the sound synthesis.

The present inventors have recognized that the computational effort involved in synthesizing sound in the frequency domain or QMF domain are caused by the fact that the synthesis of transients and noise in a transform domain is inefficient and significantly increases the complexity of the sound synthesis.

It is an object of the present invention to overcome these and other problems of the Prior Art and to provide a device for producing sound represented by sets of parameters which allows the synthesis of sound to be greatly simplified.

Accordingly, the present invention provides a device for producing sound represented by sets of parameters, each set comprising sinusoidal parameters representing sinusoidal components of the sound and additional parameters representing additional components of the sound, the device comprising:

a first sinusoidal components production unit for producing sinusoidal components of a first output channel only,

a second sinusoidal components production unit for producing sinusoidal components of a second output channel only,

at least one additional components production unit for producing additional components of both the first output channel and the second output channel, and

a first combination unit and a second combination unit for combining the additional components with the sinusoidal components of the first output channel and the second output channel respectively.

By providing a separate sinusoidal components production unit for each output channel but a shared additional components production unit, the number of production units is reduced, and hence the complexity of the device is reduced as well. In the device of the present invention, the sinusoidal components are produced for each channel individually, while the additional components, such as noise and/or transients components, are produced by a production unit common to the output channels. Accordingly, the device of the present invention has at least one production unit less than the device of the Prior Art.

The present invention is based upon the insight that sinusoidal sound components contain most directional information, or at least the most detailed directional information, and that in particular noise contains very little directional information, or very coarse directional information. This allows the same noise components to be used for both (or all) channels. These shared noise (in general: additional) components are combined with the channel-specific sinusoidal components in suitable combination units, so as to produce output channels that contain both sinusoidal components indicative of the particular channel and generic noise components.

In a preferred embodiment, the device of the present invention further comprises:

two additional components production units for producing a first type of additional components and a second, different type of additional components respectively, and

at least one further combination unit for combining the additional components produced by the two additional components production units.

By providing two production units for additional components, both noise and transients (and/or any other additional components) common to the output channels may be provided. As a result, both dual (or multiple) noise production units and dual (or multiple) transients production units are avoided. In this embodiment, therefore, the first additional components production unit may advantageously be arranged for producing transient components and the second additional components production unit may advantageously be arranged for producing noise components.

It is preferred that the device further comprises first and second weighting units for weighting the additional components. This allows the level of common additional components to be varied per output channel, thus providing a more realistic sound reproduction.

In a particularly advantageous embodiment, the sinusoidal components production units are transform domain production units and the additional components production units are time domain production units. In this embodiment, therefore, only the sinusoidal components are synthesized in the transform (e.g. frequency) domain, which synthesis can be performed very efficiently. The additional components, such as noise and transients components, are synthesized in the time domain, thus avoiding the inefficient transform domain synthesis of these components. As a result, a very significant complexity reduction is obtained.

This particularly advantageous embodiment preferably further comprises a transform unit for transforming sinusoidal parameters to the transform domain, and a direction control unit for adding directional information to the transformed sinusoidal parameters so as to produce the first output channel and the second output channel. This preferred embodiment is particularly suitable for use as a parametric decoder.

In another advantageous embodiment, the production units are arranged for receiving multiple sets of parameters, the sets being associated with different input channels. This embodiment is particularly suitable for use as a synthesizer, for example a MIDI synthesizer.

Although the device of the present invention has been discussed above with reference to only two output channels, the present invention is not so limited. More in particular, the device of the present invention may be arranged for producing at least three output channels, preferably six output channels. It will be understood that six output channels may be used in so-called 5.1 sound systems which include five regular sound output channels (left front, left rear, right front, right rear, and center) plus a sub-woofer for bass production. When the device of the present invention is arranged for three or more output channels, it has at least three sinusoidal components production units, and less than three additional components production units. Preferably, the device still has a single, shared additional components production unit per additional component type, the said type being, for example, noise or transients.

As mentioned above, the device of the present invention may advantageously be a MIDI synthesizer or a parametric sound decoder, such as a parametric stereo or multi-channel decoder.

A sound system may advantageously comprises a device as defined above. Such a sound system may be a consumer sound system including an amplifier and loudspeakers or similar transducers. Other sound systems may include musical instruments, telephone devices such as mobile (cellular) telephones, portable audio players such as MP3 and AAC players, computer sound systems, etc.

The present invention also provides a method of producing sound represented by sets of parameters, each set comprising sinusoidal parameters representing sinusoidal components of the sound and additional parameters representing additional components of the sound, the method comprising the steps of:

producing sinusoidal sound components of a first channel only,

producing sinusoidal sound components of a second channel only,

producing additional sound components of both the first channel and the second channel, and

combining the additional sound components with the sinusoidal components of the first channel and the second channel respectively.

This method, in which sinusoidal sound components of a first channel, sinusoidal sound components of a second channel, and additional sound components of both channels are produces in separate steps, has the same advantages as the device defined above.

The method of the present invention may advantageously comprise the additional steps of:

producing a first type of additional components and a second, different type of additional components, and

combining the two types of additional components.

In a typical embodiment, the first type of additional components includes transients and the second type of additional components includes noise.

The method may further comprise the step of weighting the additional components, preferably prior to mixing these additional components with the individual (output) channels.

In a particularly advantageous embodiment of the method according to the present invention, the sinusoidal components are produced in the transform domain, and the additional components are produced in the time domain. This greatly reduces the complexity and computational effort involved in the inventive method.

The method of the present invention may further comprise the steps of transforming sinusoidal parameters to the transform domain, and adding directional information to the transformed sinusoidal parameters so as to produce the first output channel and the second output channel. By adding directional information, such as stereo information, two or more output channels may be created out of a single source of sinusoidal parameters. By adding and processing the directional information in the transform domain, individual output channels can be generated efficiently.

The present invention additionally provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

The present invention will further be explained below with reference to exemplary embodiments illustrated in the accompanying drawings, in which:

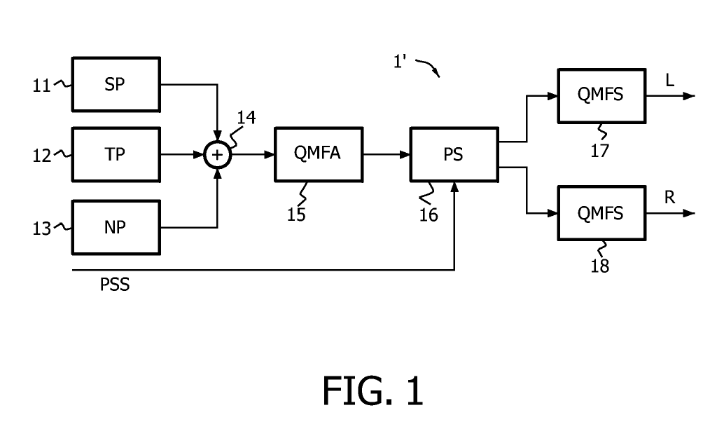

FIG. 1 schematically shows a parametric stereo decoder according to the Prior Art.

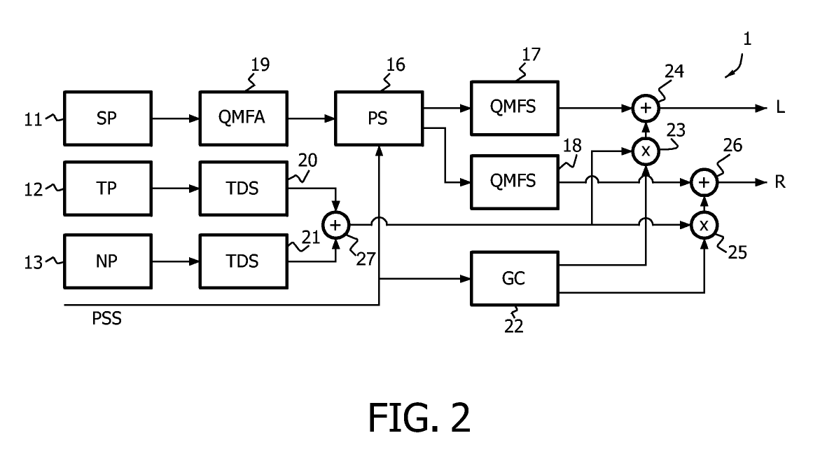

FIG. 2 schematically shows a parametric stereo decoder according to the present invention.

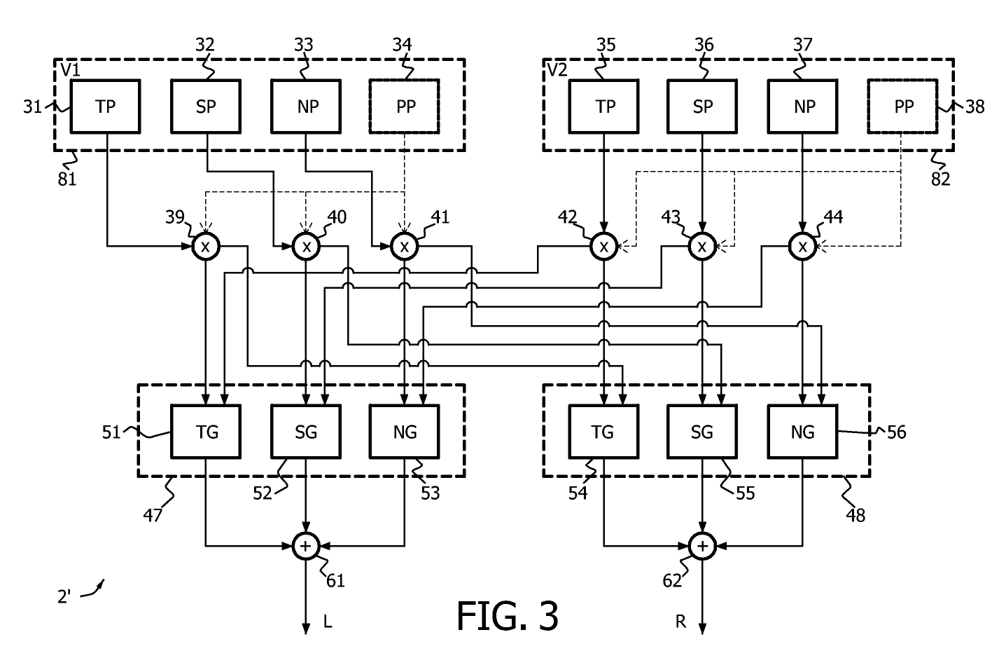

FIG. 3 schematically shows a parametric stereo synthesizer according to the Prior Art.

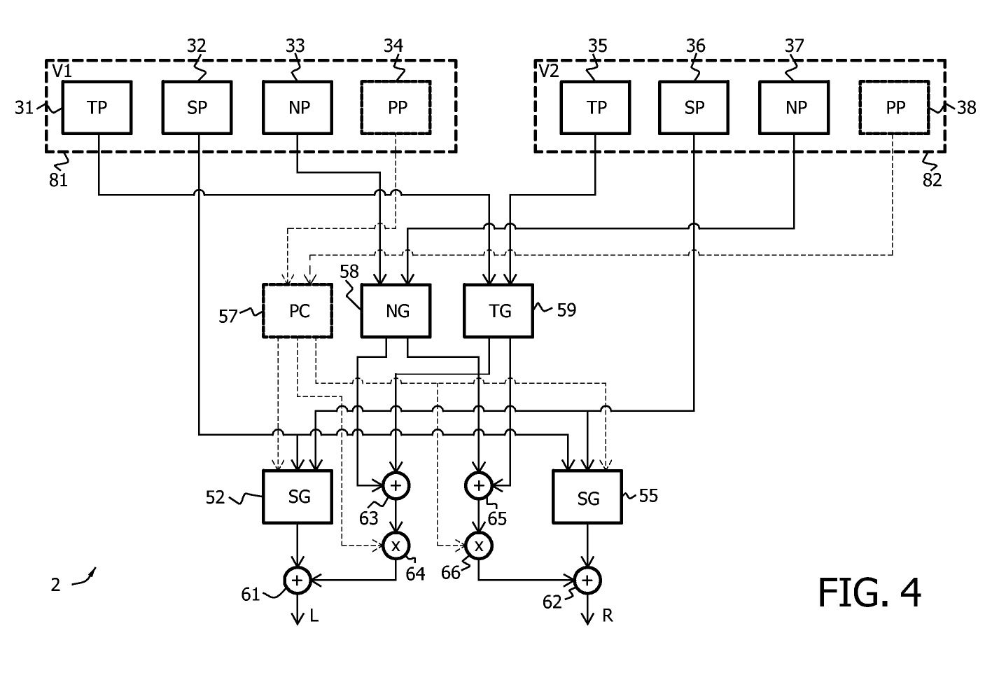

FIG. 4 schematically shows a parametric stereo synthesizer according to the present invention.

The parametric stereo decoder 1′ according to the Prior Art which is shown by way of example in FIG. 1 comprises a sinusoids source 11, a transients source 12 and a noise source 13, a combination unit 14, a QMF analysis (QMFA) unit 15, a parametric stereo (PS) unit 16, a first QMF synthesis (QMFS) unit 17 and a second QMF synthesis (QMFS) unit 18.

The sinusoids source 11, the transients source 12 and the noise source 13 produce sinusoids parameters (SP), transients parameters (TP) and noise parameters (NP) respectively and feed these parameters to the combination unit (adder) 14. The parameters may have been stored in the sources 11, 12 and 13, or may have been provided via these sources, for example from a demultiplexer.

The combination unit 14 feeds the combined parameters to the QMF analysis (QMFA) unit 15. This QMF analysis unit 15 transforms the parameters from the time domain to the QMF (Quadrature Mirror Filter) domain, which is equivalent to the frequency domain. The QMF analysis unit 15 may comprise one or more QMF filters, but may also be constituted by a filter bank and one or more FFT (Fast Fourier Transform) units. The resulting QMF (or frequency) domain parameters are then processed by the parametric stereo (PS) unit 16, which also receives a parametric stereo signal PSS containing stereo information. Using the stereo information, the parametric stereo unit produces a set of left (QMF domain) parameters and a set of right (QMF domain) parameters which are fed to a left QMF synthesis (QMFS) unit 17 and a right QMF synthesis (QMFS) unit 18. The QMF synthesis units 17 and 18 transform the sets of QMF domain parameters to the time domain, so as to produce a left signal L and a right signal R respectively.

Although the arrangement 1′ of FIG. 1 may work well, it involves a large computational effort. In particular the synthesis in the QMF (frequency) domain is very complex and is therefore not efficient. The circuits required for this synthesis are therefore expensive while still involving a relatively slow processing.

The present inventors have recognized that the computational effort involved in synthesizing sound in the frequency domain or QMF domain are caused by the fact that transients and noise are very difficult to synthesize efficiently. In contrast, the synthesis of sinusoids in the frequency or QMF domain can be carried out efficiently. As in a parametric decoder sinusoidal parameters and at least one of transient parameters and noise parameters are available, a separate synthesis can be carried out, depending on the type of parameters. Accordingly, in the decoder of the present invention the sinusoidal components are synthesized in the frequency domain or its equivalent (e.g. QMF), while the other component or components are synthesized in another domain, preferably the time domain. A preferred embodiment of a decoder according to the present invention is illustrated in FIG. 2.

The parametric stereo decoder 1 according to the present invention which is illustrated merely by way of non-limiting example in FIG. 2 also comprises a sinusoids source 11, a transients source 12 and a noise source 13. The decoder 1 further comprises a parametric stereo (PS) unit 16, a first QMF synthesis (QMFS) unit 17 and a second QMF synthesis (QMFS) unit 18, a QMF analysis (QMFA) unit 19, a first time domain synthesis (TDS) unit 20, a second time domain synthesis (TDS) unit 21, a gain calculation (GC) unit 22, a first multiplication unit 23, a first combination unit 24, a second multiplication unit 25, a second combination unit 26, and a third combination unit 27.

The sinusoids source 11, the transients source 12 and the noise source 13 produce sinusoids parameters (SP), transients parameters (TP) and noise parameters (NP) respectively. The parameters may have been stored in the sources 11, 12 and 13, or may have been provided via these sources, for example from a demultiplexer.

In accordance with the present invention, only the sinusoid parameters (SP) are fed to the QMF analysis (QMFA) unit 19. This QMF analysis unit 19, which essentially corresponds with the QMFA unit 15 of FIG. 1, transforms the parameters from the time domain to the QMF (Quadrature Mirror Filter) domain, which is essentially equivalent to the frequency domain. The QMF analysis unit 19 may comprise one or more QMF filters which may be known per se, but may also be constituted by a filter bank and one or more FFT (Fast Fourier Transform) units which may be known per se. The resulting QMF (or frequency) domain parameters are then processed by the parametric stereo (PS) unit 16, which also receives a parametric stereo signal PSS containing stereo information. Using the stereo information, the parametric stereo unit 16 produces a set of left (QMF domain) parameters and a set of right (QMF domain) parameters which are fed to the left QMF synthesis (QMFS) unit 17 and the right QMF synthesis (QMFS) unit 18 respectively. These QMF synthesis units 17 and 18 transform the sets of QMF domain parameters to the time domain, and these transformed parameters are fed to the first combination unit 24 and the second combination unit 26 respectively. In the embodiment shown, the combination units 24 and 26 are constituted by adders, but the invention is not so limited, and other combination units can be envisaged, including weighing units.

In the decoder of the present invention, only the sinusoidal parameters (SP) are fed to a QMF analysis unit (19 in FIG. 2). The transient parameters (TP) and/or noise parameters (NP) are, in accordance with the present invention, not fed to a QMF analysis unit but to time domain synthesis units 20 and 21 respectively. As a result, transients and noise are synthesized in the time domain instead of the QMF (in general: transform) domain, which greatly simplifies the synthesis. The technical structure of the time domain synthesis (TDS) units 20 and 21 may be known per se and is described in, for example, the paper “Advances in Parametric Coding for High-Quality Audio” by W. Oomen, E. Schuijers, B. den Brinker and J. Breebaart, Audio Engineering Society Convention Paper No. 5852, Amsterdam (The Netherlands), March 2003, the entire contents of which are herewith incorporated in this document.

The synthesized noise and transients are combined in the third combination unit 27, which in the embodiment shown is also constituted by an adder. The combined noise and transient signals are then fed to both a first multiplier 23 and a second multiplier 25, to be multiplied with channel-dependent gain signals produced by the gain control unit 22. The gain control (GC) unit 22 receives the parametric stereo signal PSS and derives suitable gain control signals from this signal. The gain adjusted transients and noise signals are then combined with the output signals of the QMF synthesis units 17 and 18 by the combination units 24 and 26 to produce a left output signal L and a right output signal R respectively.

As mentioned above, the analysis and synthesis of noise and/or transients in the frequency domain or QMF domain is typically inefficient and very complex. In the decoder of the present invention, this problem is solved by only synthesizing sinusoids in the QMF (or frequency) domain, and synthesizing transients and noise in the time domain. To further simplify the decoder, the synthesis of transients and noise is not performed for each channel separately, but by synthesis units (20 and 21 in FIG. 2) which are shared by all channels. Channel-dependent information is added to the common transients and noise through the gain calculation unit 22 and the multipliers 23 and 25, which determine channel-dependent gains.

It is noted that in the embodiment of FIG. 2 the transients and noise are combined (in the adder 27) before their channel-dependent gain is adjusted. As a result, the gain of the transients and the noise is controlled together and is therefore independent of the signal type (transients or noise). Embodiments can be envisaged in which the synthesized transients and noise are not combined until after their respective gains have been adjusted. In such embodiments, multipliers coupled to the gain control (GC) unit 22 could be arranged between the time domain synthesis unit 20 and the combination unit 27, and between the time domain synthesis unit 21 and the combination unit 27.

It is noted that either the transients source 12 or the noise source 13 may be omitted, in which case the third combination unit 27 may also be omitted. In typical embodiments, at least the sinusoids source 11 and the noise source 13 will be present, the transients source 12 being optional. Although a stereo (two channel) decoder has been shown in FIG. 2, the present invention is not so limited and multiple channel decoders having three or more channels may be provided in accordance with the present invention, any necessary alterations being obvious to those skilled in the art. The present invention therefore also provides a 5.1 decoder, for example.

The decoder 1 of the present invention typically operates per time slot: the analysis and synthesis is carried out per time segment (time slot or frame), which frames may partially overlap.

In addition to a decoder, the present invention also provides a synthesizer for synthesizing sound, for example using control data from a MIDI stream or a MIDI file. A sound synthesizer according to the Prior Art is schematically shown in FIG. 3.

The sound synthesizer 2′ according to the Prior Art is arranged for reproducing two “voices” or sound input channels V1 and V2, each being constituted by a parameters source. A synthesizer of this type is described in, for example, the paper “Parametric Audio Coding Based Wavetable Synthesis” by M. Szczerba, W. Oomen and M. Klein Middelink, Audio Engineering Society Convention Paper No. 6063, Berlin (Germany), May 2004.

The first parameters source 81 (voice V1) comprises a transients source 31, a sinusoids source 32, and a noise source 33 for producing transients parameters (TP), sinusoids parameters (SP) and noise parameters (NP) respectively, and an optional panning source 34 for producing panning parameters (PP). Similarly, the second parameters source 82 (voice V2) comprises a transients source 35, a sinusoids source 36, and a noise source 37 for producing transients parameters (TP), sinusoids parameters (SP) and noise parameters (NP) respectively, and an (optional) panning source 38 for producing panning parameters (PP).

The sound synthesizer 2′ further comprises a first generator block 47 comprising a first transients generator (TG) 51, a first sinusoids generator (SG) 52 and a first noise generator (NG) 53, and a second generator block 48 comprising a second transients generator (TG) 54, a second sinusoids generator (SG) 55 and a second noise generator (NG) 56. The first generator block 47 produces sound signals which are combined by a first combination unit 61 into a first (left) sound output channel L, while the second generator block 48 produces sound signals which are combined by a second combination unit 62 into a second (right) sound output channel R.

It is noted that the sound output channels L and R each contain sound originating from two sound input channels (or “voices”) V1 and V2. It is further noted that the number of sound input channels and sound output channels illustrated in FIG. 3 is only exemplary and that more than two sound input channels and/or more than two sound output channels may be present.

The sound parameters are distributed to the generators by a series of weighting units 39-44. The first weighting unit 39, for example, is coupled to the first transients parameters source 31 and to the first and second transients generators 51 and 54 so as to distribute the transients parameters of the first voice V1 over the two channels L and R. The first weighting unit 39 may use predetermined weighting factors, for example 0.5 and 0.5, or 0.4 and 0.6, but may also be controlled by panning parameters (PP) produced by the (optional) panning unit 34 of the first voice V1. In this way, all parameters are distributed over all generators.

It will be understood that the synthesizer 2′ of FIG. 3 is relatively complex, and that its complexity increases significantly when more sound input channels and/or sound output channels are added. For a so-called 5.1 sound system, six generator blocks would be needed with a total of 18 generators. This is clearly less desirable.

A synthesizer in accordance with the present invention is schematically shown by way of non-limiting example in FIG. 4. The inventive synthesizer 2 also comprises a first parameters source 81 and a second parameters source 82. The first parameters source 81 (voice V1) comprises a transients source 31, a sinusoids source 32, and a noise source 33 for producing transients parameters (TP), sinusoids parameters (SP) and noise parameters (NP) respectively, and an optional panning source 34 for producing panning parameters (PP). Similarly, the second parameters source 82 (voice V2) comprises a transients source 35, a sinusoids source 36, and a noise source 37 for producing transients parameters (TP), sinusoids parameters (SP) and noise parameters (NP) respectively, and an (optional) panning source 38 for producing panning parameters (PP).

However, in contrast to the synthesizer 2′ of the Prior Art, the inventive synthesizer 2 shown in FIG. 4 does not have multiple generator blocks (47 and 48 in FIG. 3). Instead, the synthesizer 2 has two sinusoids generators (SG) 52 and 55, one for each output sound channel, as in FIG. 3, but a single noise generator (NG) 58 and a single transients generator (TG) 59. The transients parameters (TP) from the transients sources 31 and 35 are fed to the single transients generator (TG) 59 which produces transients signals for both channels. Similarly, the noise parameters from the noise sources 33 and 37 are fed to the signal noise generator (NG) 58, which produces noise signals for both channels. For each channel, a further combination unit 63 and 65 respectively is provided for combining the noise signal and the transients signal of that channel. Then the sound level of each channel may be adjusted by level adjustment units 64 and 66 respectively, which are coupled between the combination units 63 and 61, and between the combination units 65 and 62 respectively. The level adjustment units 64 and 66 may receive weighting signals from a panning control (PC) unit 57, or may be arranged for applying fixed, predetermined weighting factors.

The (single, optional) panning control (PC) unit 57 receives panning parameters (PP) for both voices V1 and V2 from the panning units 34 and 38. The unit 57 converts these panning parameters into suitable panning control signals which are fed to the level adjustment (or weighting) units 64 and 66, and to the sinusoids generators 52 and 55 so as to control the output sound levels and thereby determine the direction of the output sound.

When comparing FIGS. 3 and 4, it is clear that the synthesizer 2 of FIG. 4 is much simpler than the Prior Art synthesizer 2′ of FIG. 3. In addition, the synthesizer 2 of the present invention can easily be altered so as to include more input sound channels and/or output sound channels without significantly increasing its complexity. The number of noise generators (NG) and transients generators (TG) will not be increased, as these generators are shared among the output channels. Only the number of sinusoids generators will have to be increased, plus the associated combination and weighting units per output channel.

It is noted that the panning parameters (PP) units 34 and 38, the panning control unit 57 and the level adjustment units 64 and 66 are optional and that the invention may be practiced without these units. However, these units will be present in preferred embodiments of the invention.

It is further noted that the parameter sources 31-38 may be external to the synthesizer 2. In other words, a synthesizer according to the present invention can be envisaged which has input terminals for receiving transients parameters, sinusoids parameters, noise parameters and/or panning parameters, which input terminals then constitute the sources 31-38. In some embodiments, transients parameters and the associated components of the synthesizer may be omitted, the synthesizer being arranged for producing noise and sinusoids only. In other embodiments, multiple transients generators may be provided while only the noise generator is shared between the output channels.

In order to improve the localization of sound while sharing generators among the output channels, post-processing units may be applied, such as filters and delay lines. In this way, an improved directional processing (panning) is achieved. This may be particularly advantageous when producing 3D (three dimensional) sound, where positioning is achieved by filtering (typically using HRTFs—Head Related Transfer Functions—which are well known in the Art) and mapping onto a limited number of channels.

Other post-processing operations may be carried out, for example adding reverberation and chorus effects. By only applying reverberations to the sinusoidal components of the synthesized sound signal, the complexity of the synthesizer is significantly reduced while the reduction of the reverberation effect is hardly perceptible.

As mentioned above, the synthesizer of the present invention is not limited to stereo applications, but may also be used for multiple channel applications having three or more channels, for example for 5.1 sound systems. The processing of the parameters is preferably performed per time segment, each parameter defining a signal type (noise, transient or sinusoid) for a particular time segment (e.g. a frame).

The present invention is based upon the insight that only sinusoidal components can be efficiently synthesized in the spectral domain. The present invention is based upon the further insight that the human ear is less sensitive to the direction of transient and noise signal components than to the direction of sinusoidal signal components. It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A device (1, 2) for producing sound represented by sets of parameters, each set comprising sinusoidal parameters (SP) representing sinusoidal components of the sound and additional parameters (NP, TP) representing additional components of the sound, the device comprising:
a first sinusoidal components production unit (17; 52) for producing sinusoidal components of a first output channel (L) in response to the sinusoidal parameters,
a only second sinusoidal components production unit (18; 53) for producing sinusoidal components of only a second output channel (R) in response to the sinusoidal parameters,
at least one additional components production unit (20, 21; 58, 59) for producing common additional components for the first output channel (L) and the second output channel (R) in response to the additional parameters, and
a first combination unit (24; 62) for generating the first output channel and a second combination unit (26; 62) for generating the second output channel in response to combining the common additional components with the sinusoidal components of the first output channel (L) and the second output channel (R) respectively,
and wherein the common additional components are at least one of transient components and noise components.

2. The device according to claim 1, comprising:
two additional components production units (20, 21; 58, 59) for producing a first type of additional components and a second, different type of additional components respectively, and
at least one further combination unit (27; 63, 65) for combining the additional components produced by the two additional components production units.

3. The device according to claim 2, wherein the first additional components production unit (20; 59) is arranged for producing transients and the second additional components production unit (21; 58) is arranged for producing noise.

4. The device according to claim 1, further comprising first and second weighting units (23, 25; 64, 66) for weighting the common additional components for the first output channel (L) and the second output channel (R) respectively.

5. The device according to claim 1, wherein the sinusoidal components production units (17, 18; 52, 55) are transform domain production units, and wherein the additional components production units (20, 21) are time domain production units.

6. The device according to claim 5, further comprising a transform unit (19) for transforming sinusoidal parameters (SP) to the transform domain, and a direction control unit (16) for adding directional information (PSS) to the transformed sinusoidal parameters so as to produce the first output channel (L) and the second output channel (R).

7. The device according to claim 1, wherein the production units (52, 55, 58, 59) are arranged for receiving multiple sets of parameters, the sets being associated with different input channels (V1, V2).

8. The device according to claim 1, arranged for producing at least three output channels, preferably six output channels.

9. The device according to claim 1, which is a MIDI synthesizer.

10. The device according to claim 1, which is a parametric sound decoder.

11. A sound system, comprising a device (1, 2) according to claim 1.

12. A method of producing sound represented by sets of parameters, each set comprising sinusoidal parameters (SP) representing sinusoidal components of the sound and additional parameters (NP, TP) representing additional components of the sound, the method comprising the steps of:
producing sinusoidal components of only a first output channel (L) in response to the sinusoidal parameters,
producing sinusoidal components of a only second output channel (R) in response to the sinusoidal parameters,
producing common additional components for the first output channel (L) and the second output channel (R) in response to the additional parameters, and
generating the first output channel (L) and the second output channel (R) in response to combining the common additional components with the sinusoidal components of the first output channel (L) and the second output channel (R) respectively,
and wherein the common additional components are at least one of transient components and noise components.

13. The method according to claim 12, comprising the additional steps of:
producing a first type of additional components and a second, different type of additional components, and
combining the two types of additional components.

14. The method according to claim 13, wherein the first type of additional components includes transients and the second type of additional components includes noise.

15. The method according to claim 12, further comprising the step of weighting the common additional components for the first output channel (L) and the second output channel (R) respectively.

16. The method according to claim 12, wherein the sinusoidal components are produced in the transform domain, and wherein the additional components are produced in the time domain.

17. The method according to claim 16, further comprising the steps of transforming sinusoidal parameters (SP) to the transform domain, and adding directional information (PSS) to the transformed sinusoidal parameters so as to produce the first output channel (L) and the second output channel (R).

18. A computer program product for carrying out the method according to claim 12.
